(19) United States
(12) Patent Application Publication
(10) Pub. No.: US 2025/0121690 A1
(43) Pub. Date: Apr. 17, 2025

(54) SYSTEM AND METHOD FOR PROVIDING SELF-DIAGNOSTIC CHECK FOR AN ACTIVE DISCHARGE CIRCUIT IN ELECTRIC VEHICLE APPLICATIONS

(71) Applicant: Ford Global Technologies, LLC, Dearborn, MI (US)

(72) Inventors: Petros G. Taskas, Novi, MI (US); Baoming Ge, Okemos, MI (US)

(21) Appl. No.: 18/488,242

(22) Filed: Oct. 17, 2023

(51) Int. Cl. B60L 3/00; B60L 3/04

(52) U.S. Cl. CPC B60L 3/0046; B60L 3/04; B60L 2240/547

(57) ABSTRACT

A discharge system for a drive system includes a discharge circuit, a sensor, and a control system. The discharge circuit is connected in parallel to the drive system, and is operable in an ON-position to be electrically coupled to the drive system or an OFF-position to be electrically decoupled from the drive system. The sensor is arranged in series with the discharge circuit to detect an electrical characteristic of the discharge circuit. The control system is configured to, for a diagnostic check, operate the discharge circuit in the ON-position, and provide a notification in response to the electric characteristic detected being unresponsive to the discharge circuit being in the ON-position.

### TECHNICAL FIELD

The present disclosure is generally directed to a discharge system for a vehicle electric drive system.

### BACKGROUND

Electric vehicles (EV), such as fully electric vehicles, hybrid electric vehicles (HEVs), and plug-in hybrid electric vehicles (PHEVs), use inverter-driven electric motors to provide traction torque and regenerative braking torque. A relatively large energy storage capacitor (i.e., a direct current (DC) link capacitor) is generally employed by the inverter as a DC link to maintain a desired bus voltage and absorb switching related ripples. The DC link capacitor is also connected to a high-voltage (HV) battery (i.e., a traction battery of the EV) through a pair of mechanical contactors (e.g., relays).

### SUMMARY

In one form, the present disclosure is directed to a discharge system for a drive system. The discharge system includes a discharge circuit, a sensor, and a control system. The discharge circuit is connected in parallel to the drive system, and is operable in an ON-position to be electrically coupled to the drive system or an OFF-position to be electrically decoupled from the drive system. The sensor is arranged in series with the discharge circuit to detect an electrical characteristic of the discharge circuit. The control system is configured to, for a diagnostic check, operate the discharge circuit in the ON-position, and provide a notification in response to the electric characteristic detected being unresponsive to the discharge circuit being in the ON-position.

In one form, the present disclosure is directed to a method including detecting, by a sensor arranged in series with a discharge circuit of a drive system, an electrical characteristic of the discharge circuit. The discharge circuit is connected in parallel to the drive system, and operable in an ON-position to be electrically coupled to the drive system or an OFF-position to be electrically decoupled from the drive system. The method further includes, for a diagnostic check, operating, by a control system, the discharge circuit in an ON-position to have the discharge circuit electrically coupled to the drive system, and providing, by the control system, a notification in response to the electric characteristic detected being unresponsive to the discharge circuit being in the ON-position.

In one form, the present disclosure is directed to a discharge system for a drive system. The discharge system includes a discharge circuit, a sensor, and a control system. The discharge circuit is connected in parallel to a DC link capacitor of the drive system. The discharge circuit includes a discharge resistor and a discharge power switch connected in series with the discharge resistor, where the discharge power switch is operable in an ON-position to electrically couple the discharge resistor to the DC link capacitor or an OFF-position to be electrically decouple the discharge resistor from the DC link capacitor. The sensor is arranged in series with the discharge circuit to detect an electrical characteristic of the discharge circuit. The control system is configured to operate the discharge power switch to electrically couple or decouple the discharge resistor and the drive system. For a diagnostic check, the control system is configured to operate the discharge power switch in the ON-position, and provide a notification indicating the discharge circuit is deficient in response to the electric characteristic detected being unresponsive to the discharge circuit being in the ON-position.

### BRIEF DESCRIPTION OF THE DRAWINGS

FIG. 1 is an example circuit diagram of a system having a drive system and a discharge system having a diagnostic check in accordance with the present disclosure;

FIG. 2 is another example circuit diagram of a system having the drive system and a discharge system having a diagnostic check in accordance with the present disclosure; and

FIG. 3 is a flowchart of an example diagnostic check routine in accordance with the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

During certain shutdown events, such as but not limited, an EV OFF-state, a high-voltage DC interlock fault, or a vehicle accident, the traction battery is quickly isolated from the rest of the drive system of the EV by opening one or more mechanical relays. However, there can still be a high electric charge in the DC link capacitor (e.g., 400V, 800V), and, to meet certain standards, the electric charge should be quickly discharged within a specific time.

In some EVs, a discharge circuit having a resistor and a switch is provided across the DC link capacitor to dissipate the electric charge of the capacitor. In operation, the switch (e.g., a transistor switch) electrically couples the resistor to the DC link capacitor dissipating electric charge in the capacitor. Currently, EVs may not have a way to perform diagnostics on the discharge circuit itself, so it may be difficult to know if the discharge circuit is operational or deficient.

The present disclosure provides a discharge system having a diagnostic check to detect whether the discharge circuit is operational or deficient. More particularly, as described herein, the discharge system includes a sensor arranged in series with the discharge circuit to detect an electrical characteristic of the discharge circuit, and a control system configured to perform a diagnostic check to identify the discharge circuit as being deficient or operational based on the electrical characteristic. Specifically, with the discharge circuit being provided in a ON-position in which the discharge circuit is to dissipate electrical energy from the DC link capacitor, the control system determines whether the electrical characteristic detected by the sensor is responsive to the discharge circuit being in the ON-position. If there is no change in the electrical characteristic or no electrical current/voltage, the discharge system identifies the discharge circuit as being deficient and may provide a notification to a user/technician to initiate further analysis of the discharge circuit. Accordingly, the discharge system of the present disclosure provides a self-diagnostic check of the discharge system.

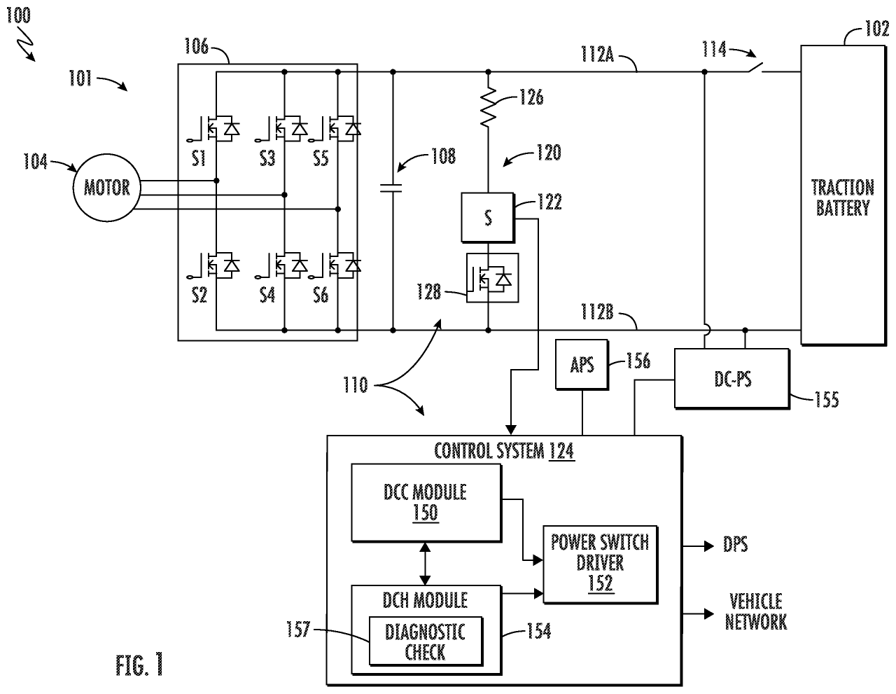

Referring to FIG. 1, among other components, an EV system 100 includes a drive system 101 including a battery pack 102 (i.e., a traction battery), an electric motor 104, an inverter 106, and a DC link capacitor 108. The EV system 100 further includes a discharge system 110 configured to dissipate electric energy from the drive system 101, and specifically, the DC link capacitor 108.

The inverter 106 is electrically coupled to the battery pack 102 across a positive power bus 112A and a negative power bus 112B (collectively “power buses 112”) with a relay 114 arranged on at least one of the power buses 112 to electrically decouple the battery pack 102 from the rest of the drive system 101 during shutdown events. As known, the inverter 106 include multiple switches S1-S6, that are operable to convert DC power from the battery pack 102 to alternating current (AC) to rotate the motor 104.

The DC link capacitor 108 is electrically coupled in parallel to the inverter 106, and specifically, is coupled to the power buses 112A and 112B between the battery pack 102 and the inverter 106.

The discharge system 110 for the drive system 100 is configured to discharge electric power stored in the DC link capacitor 108 during shutdown events. In one form, the discharge system 110 includes a discharge circuit 120 connected in parallel to the drive system 101, a sensor 122 to detect an electrical characteristic of the discharge circuit 120, and a control system 124 configured to control operation of the discharge system 110.

The discharge circuit 120 is connected to the positive power bus 112A and the negative DC power bus 112B to be connected in parallel with the DC link capacitor 108. In one form, the discharge circuit 120 includes a discharge resistor 126 to dissipate the energy in the DC link capacitor 108 and a discharge power switch (DPS) 128 connected in series with the discharge resistor 126. The discharge power switch 128 is operable to electrically couple the discharge resistor 126 and the DC link capacitor 108. Specifically, when the discharge power switch 128 is in an ON-position, the switch 128 is to electrically couple the discharge resistor 126 and the capacitor 108, and if in an OFF-position, the switch 128 is to electrically decouple the discharge resistor 126 and the capacitor 108. The terms “ON-position” and “OFF-position” represent the discharge state of the discharge circuit 120, and is not intended to reflect whether power is being applied to the discharge power switch 128. That is, the discharge power switch 128 may be a suitable transistor (e.g., MOSFET) that is a normally open switch or, alternatively, a normally close switch.

The sensor 122 is arranged in series with the discharge circuit 120 to detect an electrical characteristic of the discharge circuit 120, and is configured to provide an electrical signal indicative of the electrical characteristic and detectable by the control system 124. In one form, the sensor 122 is provided as an electric current detector configured to detect, as the electrical characteristic, electric current through the discharge circuit 120. In a non-limiting example, the electric current detector includes an opto-isolator, also known as an optocoupler, that transfers electrical signals between the discharge circuit 120 and the control system 124 in response to an electric current flowing through the discharge circuit 120. Other suitable sensors may be used such as a voltage sensor having a resistor and detecting a voltage drop across the resistor.

The control system 124 is configured to operate the discharge power switch 128 to electrically couple or decouple the discharge resistor 126 and the drive system 101. In one form, the control system 124 includes a discharge circuit control (DCC) module 150, a power switch driver 152, and a discharge circuit health (DCH) module 154. While illustrated as two modules, the DCC module 150 and the DCH module 154 may be provided combined into one or more modules/devices. The power switch driver 152 is adapted to drive or operate the power switch 128 to control a position of the discharge power switch 128. In a non-limiting example, the power switch driver 152 employs a DC power source (DC-PS) 155 that is electrically coupled to the power buses 112A, 112B and includes a power converter to reduce (i.e., step-down) the high DC voltage of the DC buses 112A, 112B to a low DC voltage (e.g., 12V, 15V, etc.) to drive the discharge power switch 128.

The DCC module 150 is configured to control the power switch 128 of the discharge circuit 120 to couple/decouple the discharge circuit 120 to/from the drive system 101 for a shutdown event. In a non-limiting example, the DCC module 150 detects electric power from an auxiliary power source (APS) 156 that provides low voltage DC power to devices in the EV, such as a 12V battery. In the event no power is received from the APS 156, the DCC module 150 is configured to operate the discharge power switch 128 using the DC power source 155 to electrically couple the discharge circuit 120 and the DC link capacitor 108 to dissipate the electric energy in the capacitor 108.

The DCH module 154 is configured to perform a diagnostic check 157 on the discharge circuit 120 to determine if the discharge circuit 120 is deficient or operational. More particularly, for the diagnostic check 157, the DCH module 154 is configured to adjust electric power through the discharge circuit 120, and detect a response of the discharge circuit 120. Stated differently, to adjust the electric power through the discharge circuit 120, the DCH module 154 operates the discharge power switch 128 to electrically couple the discharge circuit 120 to the drive system 101, and specifically electrically coupling the discharge resistor 126 and the DC link capacitor 108. If the discharge circuit 120 is operational, electric current should flow through the discharge resistor 126 and thus, the sensor 122, and thus, the discharge circuit 120 is responsive to a change in the electric power through the discharge circuit 120. Conversely, if no electric current (i.e., electric characteristic) flows through the discharge resistor 126, the discharge circuit 120 is unresponsive, and thus, the discharge circuit 120 is identified as being deficient. Accordingly, for the diagnostic check, the DCH module 154 is configured to identify the discharge circuit 120 as being deficient in response to the electric characteristic detected being unresponsive to the electric power being adjusted, and to identify the discharge circuit 120 as being operational in response to the electric characteristic detected being responsive to the electric power being adjusted.

In the event the discharge circuit 120 is identified as being deficient, the DCH module 154 is configured to provide a notification to, for example, a user of the vehicle, the manufacturer of the vehicle, technician, and/or owner of the vehicle. In a non-limiting example, the notification may be provided, via a vehicle network, to another module/system in the EV to be displayed at an infotainment system of the EV, displayed at a dashboard of the EV, and/or transmitted as a message via wireless communication to the receipt.

In some variations, in the event the discharge circuit 120 is identified as being deficient, the DCH module 154 is configured to perform one or more additional checks prior to/after sending the notification. Specifically, the DCH module 154 performs an ON-OFF test as part of the diagnostic check 157 in which the power switch 128 of the discharge circuit 120 is the ON-position to couple the discharge circuit 120 to the DC link capacitor 108 for a short period of time (e.g., 1-2 microsecond) and then is provided in the OFF-position to decouple the discharge circuit 120 to the DC link capacitor 108 when the EV is turned ON. If the electrical characteristics changes such that an electrical signal to DCH module 154 from the sensor 122 changes, the discharge circuit 120 is operational. Alternatively, if the electrical characteristics does not change such that the electrical signal to the DCH module 154 does not change (i.e., is remains high or remains low), the discharge circuit 120 is deficient. If the discharge circuit 120 is deficient, the DCH module 154 provides a notification indicating the discharge circuit 120 is deficient to, for example, initiate repairs.

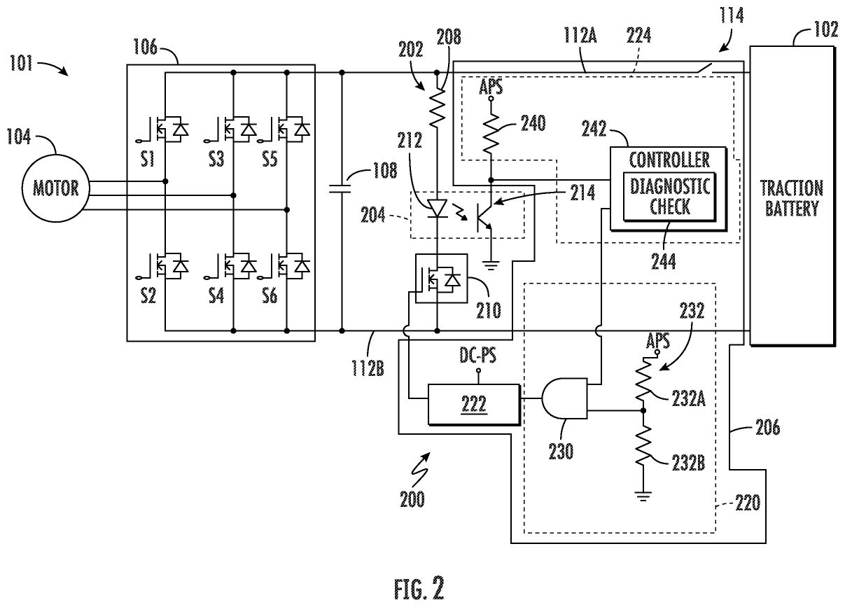

Referring, to FIG. 2, an example implementation of the discharge system 110 is provided. Specifically, a discharge system 200 which can be provided as the discharge system 110 includes a discharge circuit 202, a sensor 204, and a control system 206. The discharge circuit 202 includes a discharge resistor 208 and a discharge power switch 210, with the sensor 204 arranged in series with the discharge circuit 202.

The sensor 204 is provided as optocoupler that transmits an electrical signal to the control system 206. The sensor 204 includes a photodiode 212 arranged between the discharge resistor 208 and the power switch 210, and a phototransistor 214 in communication with the control system 206.

The control system 206 includes a DCC module 220, a power switch driver 222 (i.e., a gate driver) connected to the discharge power switch 210, and a DCH module 224. The DCC module 220 includes an AND logic unit 230, a voltage divider 232 formed by resistors 232A and 232B, and electrically coupled to the APS 156. The AND logic unit 230 receives input signals from the voltage divider 232 and the DCH module 224, and is configured to have the power switch driver 222 drive the discharge power switch 210 to the ON-position when one of the input from the AND logic unit 230 or the DCH module 224 is a low level or both inputs are low level. are the same.

The DCH module 224 is configured to include a pull-up resistor 240 electrically coupled to the APS 156 and to the phototransistor 214 of the sensor 204, and a controller 242 configured to perform a diagnostic check 244 and adapted to detect a signal from a circuit formed by the phototransistor 214 and the pull-up resistor 240.

In operation, for the diagnostic check 244, the controller 242 provides a low-signal (e.g., 0V) to the AND logic unit 230 to place the discharge power switch 210 in the ON-position electrically coupling the discharge resistor 208 and the capacitor 108. That is, with power being provided by the APS 156 to the voltage divider 232 of the DCC module 220, one input to the AND logic unit 230 is high-signal, and therefore, to operate the discharge power switch 210, the controller 242 provides a low-signal to the AND logic unit 230.

If in the ON-position, electric current should flow through the discharge resistor 208 and the photodiode 212 causing the photodiode 212 to emit light detected by the phototransistor 214. In response, the phototransistor 214, acting like a switch, electrically couples the pull-up resistor 240 to ground and the controller 242 detects a low voltage electric signal indicating that the discharge circuit 202 is operational. Alternatively, if electric current does not flow through the discharge resistor 208 because, for example, the discharge power switch 210 is not electrically coupling the discharge resistor 208 to the capacitor 108, the photodiode 212 does not emit light and the phototransistor 214 does not ground the pull-up resistor 240. Thus, the controller 242 detects a high voltage electric signal indicating that the discharge circuit 202 is deficient.

The controller 242 is configured to provide a notification as described above in association with DCH module 154 in response to at least the discharge circuit 202 being deficient. Furthermore, the controller 242 may also be configured to perform the ON-OFF test after the discharge circuit 202 is identified as being deficient as described above with respect to the DCH module 154.

During a shutdown event, power from the APS maybe disconnected and the controller 242 may not work due to no power. The voltage divider 232 further provides a low voltage signal to the AND logic unit 230 causing the AND logic unit 230 to operate the discharge power switch 210 in the ON-position to dissipate electric energy of the DC link capacitor 108.

While the control system 206 is illustrated as a separate system, the control system 206 may be integrated within already existing vehicle systems, such as but not limited to, a drive system controller/module configured to control operation of the inverter 106 and/or a power switch system for driving switches of the inverter 106.

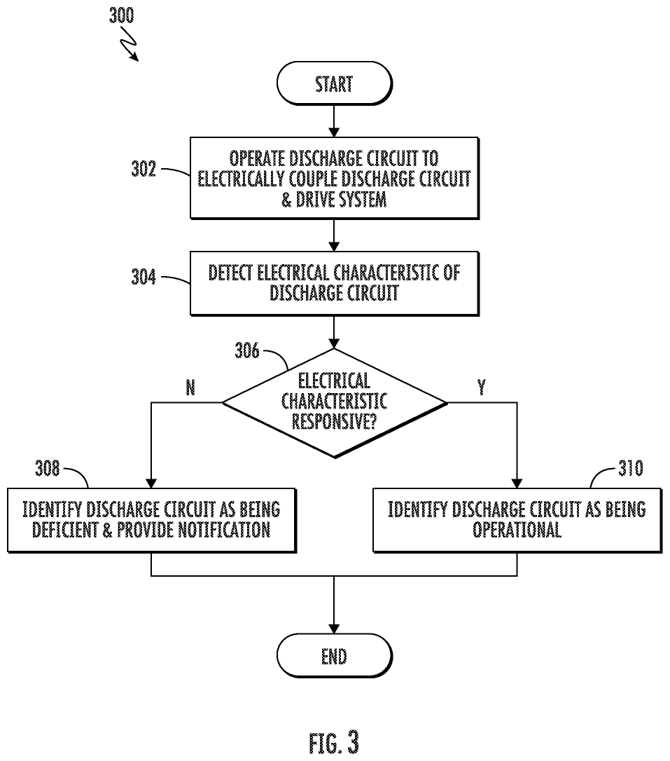

Referring to FIG. 3, an example diagnostic check routine 300 is provided and is executable by the discharge system 110, 200 of the present disclosure at selectable times. At step 302, the discharge system 110, 200 is configured to operate discharge circuit 120, 202 to electrically couple the discharge circuit 120, 202 and the drive system 101, and more specifically, electrically couple the discharge resistor 126, 208 and the DC link capacitor 108. At step 304, the discharge system 110,200 detects an electrical characteristic of the discharge circuit, via the sensor 122, 204, and at step 306 determines if the electrical characteristic is responsive to the discharge circuit 120, 202 being electrically coupled to the DC link capacitor 108. As described in detail, the sensor 122, 204 is configured to detect the electrical characteristic such as electrical current through the discharge resistor 126, 208.

In the event, electrical characteristic does not change (i.e., is unresponsive), the discharge system 110,200 identifies the discharge circuit is deficient and provides a notification, at step 308. That is, the discharge circuit 120, 202 is likely not dissipating electric energy from the DC capacitor 108 and therefore, a user is notified of the deficient discharge circuit 120, 202 for further evaluation.

Alternatively, if electrical characteristic does change (e.g., electric current begins to flow through the discharge circuit 120,202), the discharge circuit 120,202 is likely dissipating electric energy from the DC capacitor 108 and is identified as being operational at step 310. When being identified as operational, the discharge system 110,200 may store information regarding the diagnostic check 244 and the results in a memory of the EV for a selected period of time. Alternatively, the discharge system 110,200 may not take any further action once it is determined that the discharge circuit 120,202 is operational.

It should be readily understood that the diagnostic check routine 300 is just one example, and that the diagnostic check routine may be configured in various suitable ways for performing a diagnostic check of the discharge circuit 120,202 as disclosed herein. In a non-limiting example, if the discharge circuit is indicated as being unresponsive, the discharge system may perform the ON-OFF test.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A discharge system for a drive system, comprising:
a discharge circuit connected in parallel to the drive system, and operable in an ON-position to be electrically coupled to the drive system or an OFF-position to be electrically decoupled from the drive system;
a sensor arranged in series with the discharge circuit to detect an electrical characteristic of the discharge circuit; and
a control system configured to, for a diagnostic check,
operate the discharge circuit in the ON-position, and
provide a notification in response to the electric characteristic detected being unresponsive to the discharge circuit being in the ON-position.

2. The discharge system of claim 1, wherein the control system, for the diagnostic check, is configured to identify the discharge circuit as being operational in response to the electric characteristic detected being responsive to the discharge circuit being in the ON-position.

3. The discharge system of claim 1, wherein the sensor is an electric current detector configured to detect, as the electrical characteristic, electric current through the discharge circuit.

4. The discharge system of claim 3, wherein the electric current detector includes an opto-coupler.

5. The discharge system of claim 1, wherein:
the discharge circuit includes a discharge resistor and a discharge power switch connected in series with the discharge resistor, and
the control system is configured to:
operate the discharge power switch to electrically couple or decouple the discharge resistor and the drive system, and
operate the discharge power switch to electrically couple the discharge resistor and the drive system to adjust the electric power through the discharge circuit for the diagnostic check.

6. A system comprising:
a drive system including a DC link capacitor adapted to be coupled to positive and negative DC buses between a first DC power source and an inverter; and
the discharge system of claim 1, wherein the discharge circuit is connected in parallel to the DC link capacitor.

7. The system of claim 6, wherein:
the discharge circuit includes a discharge resistor and a discharge power switch connected in series with the discharge resistor, and
the control system is configured to operate the discharge power switch to electrically couple or decouple the DC link capacitor and the discharge resistor.

8. The system of claim 7, wherein the control system is configured to drive the discharge power switch to have the discharge circuit in the ON-position.

9. The system of claim 7, wherein the control system is configured to:
detect that a second DC power source adapted to provide power to the control system is not providing power; and
operate the discharge power switch to have the discharge circuit in the ON-position to electrically couple the DC link capacitor and the discharge resistor using power from the first DC power source.

10. A method comprising:
detecting, by a sensor arranged in series with a discharge circuit of a drive system, an electrical characteristic of the discharge circuit, the discharge circuit being connected in parallel to the drive system, and operable in an ON-position to be electrically coupled to the drive system or an OFF-position to be electrically decoupled from the drive system; and
for a diagnostic check,
operating, by a control system, the discharge circuit in an ON-position to have the discharge circuit electrically coupled to the drive system, and
providing, by the control system, a notification in response to the electric characteristic detected being unresponsive to the discharge circuit being in the ON-position.

11. The method of claim 10 further comprising, for the diagnostic check, identifying, by the control system, the discharge circuit as being operational in response to the electric characteristic detected being responsive to the discharge circuit being in the ON-position.

12. The method of claim 10 further comprising, wherein the electrical characteristic is detected as an electric current through the discharge circuit by the sensor.

13. The method of claim 10, wherein the discharge circuit includes a discharge resistor and a discharge power switch connected in series with the discharge resistor, and the method further comprises:
operating, by the control system, the discharge power switch to electrically couple or decouple the discharge resistor and the drive system, and
operating, by the control system, the discharge power switch to electrically couple the discharge resistor and the drive system to adjust the electric power through the discharge circuit for the diagnostic check.

14. The method of claim 10, wherein:
the drive system includes a DC link capacitor adapted to be coupled to positive and negative DC buses between a first DC power source and an inverter; and
the discharge circuit is connected in parallel to the DC link capacitor, the discharge circuit includes a discharge resistor and a discharge power switch connected in series with the discharge resistor, wherein:
the method further comprises operating, by the control system, the discharge power switch to electrically couple or decouple the DC link capacitor and the discharge resistor.

15. The method of claim 14 further comprising driving, by the control system, the discharge power switch to have the discharge circuit in the ON-position.

16. A discharge system for a drive system, comprising:
a discharge circuit connected in parallel to a DC link capacitor of the drive system, the discharge circuit including a discharge resistor and a discharge power switch connected in series with the discharge resistor, wherein the discharge power switch is operable in an ON-position to electrically couple the discharge resistor to the DC link capacitor or an OFF-position to electrically decouple the discharge resistor from the DC link capacitor;
a sensor arranged in series with the discharge circuit to detect an electrical characteristic of the discharge circuit; and
a control system configured to:
operate the discharge power switch to electrically couple or decouple the discharge resistor and the drive system, and
for a diagnostic check,
operate the discharge power switch in the ON-position, and
provide a notification indicating the discharge circuit is deficient in response to the electric characteristic detected being unresponsive to the discharge circuit being in the ON-position.

17. The discharge system of claim 16, wherein the sensor includes at least one of an opto-coupler or a resistor.

18. A system comprising:
a drive system including a DC link capacitor adapted to be coupled to positive and negative DC buses between a first DC power source and an inverter; and
the discharge system of claim 16, the discharge circuit being connected in parallel to the DC link capacitor.

19. The system of claim 18, wherein:
the discharge circuit includes a discharge resistor and a discharge power switch connected in series with the discharge resistor, and
the control system is configured to operate the discharge power switch to electrically couple or decouple the DC link capacitor and the discharge resistor.

20. The system of claim 19, wherein the control system is configured to:
detect that a second DC power source adapted to provide power to the control system is not providing power; and
operate the discharge power switch to have the discharge circuit in the ON-position to electrically couple the DC link capacitor and the discharge resistor using power from the first DC power source.
